(19) United States
(12) Patent Application Publication
(10) Pub. No.: US 2026/0267416 A1
(43) Pub. Date: Sep. 10, 2026

(54) ELECTRONIC DEVICE

(71) Applicant: CANON KABUSHIKI KAISHA, Tokyo (JP)

(72) Inventors: MINORU SAKAIDA, Kanagawa (JP); MASAYA HOKAZONO, Kanagawa (JP)

(21) Appl. No.: 19/558,289

(22) Filed: Mar. 5, 2026

(30) Foreign Application Priority Data
Mar. 10, 2025 (JP) 2025-037715

(51) Int. Cl. G06F 3/01; G06F 3/03

(52) U.S. Cl. CPC G06F 3/016; G06F 3/011; G06F 3/0325

(57) ABSTRACT

An electronic device according to the present disclosure includes a processor, and a memory storing a program which, when executed by the processor, causes the electronic device to perform an acquisition process of acquiring information regarding a positional relationship among a tactile sense generation device, a virtual object, and a user's hand in a three-dimensional space, and perform a control process of performing control so as to notify whether a tactile sense is given to the hand when the user touches the virtual object with the hand based on the information acquired by the acquisition process.

### BACKGROUND

### Field of the Technology

The present disclosure relates to an electronic device, and particularly, to a technology for presenting a tactile sense of a virtual object.

### Description of the Related Art

Japanese Patent Laid-Open No. 2019-525344 discloses aerial tactile sense feedback (aerial haptics) using a continuous distribution of sound energy called a “sound field”. By using aerial haptics, a user can touch a virtual object in a three-dimensional space such as an augmented reality (AR) space or a mixed reality (MR) space to obtain a tactile sense without wearing a tactile glove or the like. Japanese Patent Laid-Open No. 2017-142785 discloses a technology of presenting interference between a virtual object and a real object to a user by a tactile sense.

However, in aerial haptics, an ultrasonic wave (an ultrasonic wave that forms a sound field) output from a tactile sense generation device becomes weaker as it goes farther from the tactile sense generation device, and thus the tactile sense given to the user from the tactile sense generation device also becomes weaker as it goes farther from the tactile sense generation device. Furthermore, a direction of the tactile sense given from the tactile sense generation device to the user is determined by a direction (output direction) of the ultrasonic wave output from the tactile sense generation device. Therefore, even if the user touches the virtual object, the tactile sense may not be given from the tactile sense generation device to the user. For example, when the direction of the ultrasonic wave is a direction from bottom to top, the user can obtain a tactile sense when touching the virtual object from the top near the tactile sense generation device, but cannot obtain a tactile sense (suitable tactile sense, feeling as if touching virtual object) even when touching the virtual object from the bottom. As a result, the user may feel discomfort.

### SUMMARY

The present disclosure provides a technique capable of suppressing discomfort of a user when using aerial haptics.

The present disclosure in its first aspect provides an electronic device including a processor, and a memory storing a program which, when executed by the processor, causes the electronic device to perform an acquisition process of acquiring information regarding a positional relationship among a tactile sense generation device, a virtual object, and a user's hand in a three-dimensional space, and perform a control process of performing control so as to notify whether a tactile sense is given to the hand when the user touches the virtual object with the hand based on the information acquired by the acquisition process.

The present disclosure in its second aspect provides a control method of an electronic device, including acquiring information regarding a positional relationship among a tactile sense generation device, a virtual object, and a user's hand in a three-dimensional space, and performing control so as to notify whether a tactile sense is given to the hand when the user touches the virtual object with the hand based on the acquired information.

The present disclosure in its third aspect provides a non-transitory computer readable medium that stores a program, wherein the program causes a computer to execute a control method of an electronic device, the control method including acquiring information regarding a positional relationship among a tactile sense generation device, a virtual object, and a user's hand in a three-dimensional space, and performing control so as to notify whether a tactile sense is given to the hand when the user touches the virtual object with the hand based on the acquired information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a display system.

FIG. 2 is a flowchart of tactile sense presence/absence notification processing.

FIG. 3 is a schematic diagram of an aerial haptics device in a predetermined coordinate space.

FIG. 4 is a schematic diagram of a virtual object and a hand in a predetermined coordinate space.

FIG. 5 is a schematic diagram of normal force from a virtual object.

FIGS. 6A and 6B are schematic diagrams of display images.

FIGS. 7A and 7B are schematic diagrams of display images.

FIG. 8 is a schematic diagram of an aerial haptics device in a predetermined coordinate space.

FIGS. 9A and 9B are schematic diagrams of display images.

### DESCRIPTION OF THE EMBODIMENTS

### First Embodiment

A first embodiment of the present disclosure is described.

### System Configuration

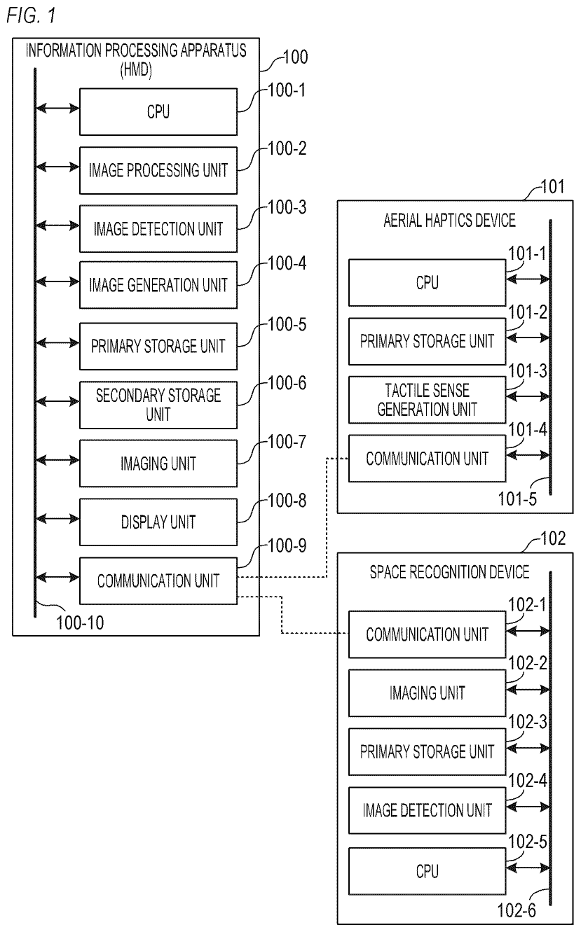

FIG. 1 is a block diagram illustrating a configuration of a display system according to the first embodiment. The display system in FIG. 1 includes an information processing apparatus 100, an aerial haptics device 101, and a space recognition device 102.

The information processing apparatus 100 is an example of an electronic device to which the present disclosure can be applied and is a wearable device such as a head-mounted display (HMD) or augmented reality (AR) glasses. The information processing apparatus 100 can provide a user with a three-dimensional space such as an augmented reality (AR) space or a mixed reality (MR) space by displaying a virtual object. Note that the electronic device to which the present disclosure can be applied may be a separate information processing device (a personal computer (PC), a controller, or the like) capable of communicating with a display device such as an HMD or AR glasses.

The aerial haptics device 101 is a tactile sense generation device that forms a sound field and gives a tactile sense to a user. For example, when the user touches a virtual object in a three-dimensional space such as an AR space or an MR space, the aerial haptics device 101 gives the user a tactile sense (a feeling as if the user touched the virtual object).

The space recognition device 102 manages information regarding a positional relationship among the aerial haptics device 101, the virtual object displayed by the information processing apparatus 100, and the hand of the user (wearer of the information processing apparatus 100) in the three-dimensional space. The space recognition device 102 transmits this information to the information processing apparatus 100. In the first embodiment, it is assumed that information regarding a position and an orientation of the aerial haptics device 101 in the three-dimensional space, information regarding a position and an orientation of the virtual object in the three-dimensional space, and information regarding a position and an orientation of the hand in the three-dimensional space are managed. Note that only the position may be managed without managing the orientation. The position (and the orientation) of the information processing apparatus 100 in the three-dimensional space may be further managed.

The information processing apparatus 100 includes a CPU 100-1, an image processing unit 100-2, an image detection unit 100-3, an image generation unit 100-4, a primary storage unit 100-5, a secondary storage unit 100-6, an imaging unit 100-7, a display unit 100-8, and a communication unit 100-9. These components are connected to a bus 100-10, and data is transmitted and received between the components via the bus 100-10.

The CPU 100-1 reads a control program from the secondary storage unit 100-6, loads the control program in the primary storage unit 100-5, and executes the control program. As a result, the CPU 100-1 controls an operation of each component included in the information processing apparatus 100.

The image processing unit 100-2 performs development processing of RAW data output from the imaging unit 100-7, synthesis of image data obtained by the development processing and image data generated by the image generation unit 100-4, and the like. As an image after the image processing by the image processing unit 100-2, a recording image to be recorded in the secondary storage unit 100-6, a display image to be displayed on the display unit 100-8, and the like are generated.

The image detection unit 100-3 detects a subject such as a hand or the aerial haptics device 101 from the image (the image representing the real space) obtained by the imaging unit 100-7 using a known method. As a detection result, for example, subject data including label data for identifying a subject, coordinate data indicating coordinates of the subject in an image, and the like is acquired. Note that subject detection processing may be performed only by an image detection unit 102-4 in the space recognition device 102.

The image generation unit 100-4 generates an image of a virtual object or the like using a known method. In the first embodiment, the image generation unit 100-4 also generates notification data for notifying whether a tactile sense is given to the hand when the user touches the virtual object with the hand. Details of a method of generating the notification data are described below. Note that an external high-performance PC may generate a higher-precision image of the virtual object and transmit the image to the information processing apparatus 100 (communication unit 100-9).

The primary storage unit 100-5 temporarily stores data used by the CPU 100-1, the image processing unit 100-2, the image detection unit 100-3, the image generation unit 100-4, the imaging unit 100-7, the display unit 100-8, the communication unit 100-9, and the like.

The secondary storage unit 100-6 stores data used by the CPU 100-1, a recording image generated by the image processing unit 100-2, and the like.

The imaging unit 100-7 includes an optical lens and an imaging element, collects light from a subject with the optical lens, forms an image on the imaging element, and converts the image into image data (RAW data) representing a real space.

The display unit 100-8 displays the display image generated by the image processing unit 100-2 at a predetermined frame rate. For example, in the display unit 100-8, the display unit 100-8 displays a display image in which a virtual object is synthesized (superimposed) in a real space so that the information processing apparatus 100 functions as a video see-through type display device.

The communication unit 100-9 communicates with a communication unit 101-4 in the aerial haptics device 101 and a communication unit 102-1 in the space recognition device 102.

The aerial haptics device 101 includes a CPU 101-1, a primary storage unit 101-2, a tactile sense generation unit 101-3, and the communication unit 101-4. These components are connected to a bus 101-5, and data is transmitted and received between the components via the bus 101-5. The CPU 101-1 controls an operation of each component included in the aerial haptics device 101. The primary storage unit 101-2 temporarily stores data used by the CPU 101-1, the tactile sense generation unit 101-3, the communication unit 101-4, and the like. The tactile sense generation unit 101-3 forms a sound field for achieving aerial haptics (aerial tactile feedback) using a known method. The tactile sense generation unit 101-3 includes, for example, a plurality of speakers (ultrasonic wave generation units) and achieves desired aerial tactile feedback by adjusting ultrasonic waves output from each speaker. The communication unit 101-4 communicates with the communication unit 100-9 in the information processing apparatus 100.

The space recognition device 102 includes the communication unit 102-1, an imaging unit 102-2, a primary storage unit 102-3, the image detection unit 102-4, and a CPU 102-5. These components are connected to a bus 102-6, and data is transmitted and received between the components via the bus 102-6. The communication unit 102-1 communicates with the communication unit 100-9 in the information processing apparatus 100. The imaging unit 102-2 includes an optical lens and an imaging element, collects light from a subject with the optical lens, forms an image on the imaging element, and converts the image into image data (RAW data) representing a real space. The primary storage unit 102-3 temporarily stores data used by the communication unit 102-1, the imaging unit 102-2, the image detection unit 102-4, the CPU 102-5, and the like. The image detection unit 102-4 performs development processing on the RAW data output from the imaging unit 102-2 and detects a subject such as a hand or the aerial haptics device 101 from the image data (image representing the real space) obtained by the development processing using a known method. The CPU 102-5 controls an operation of each component included in the space recognition device 102.

### Tactile Sense Presence/Absence Notification Processing

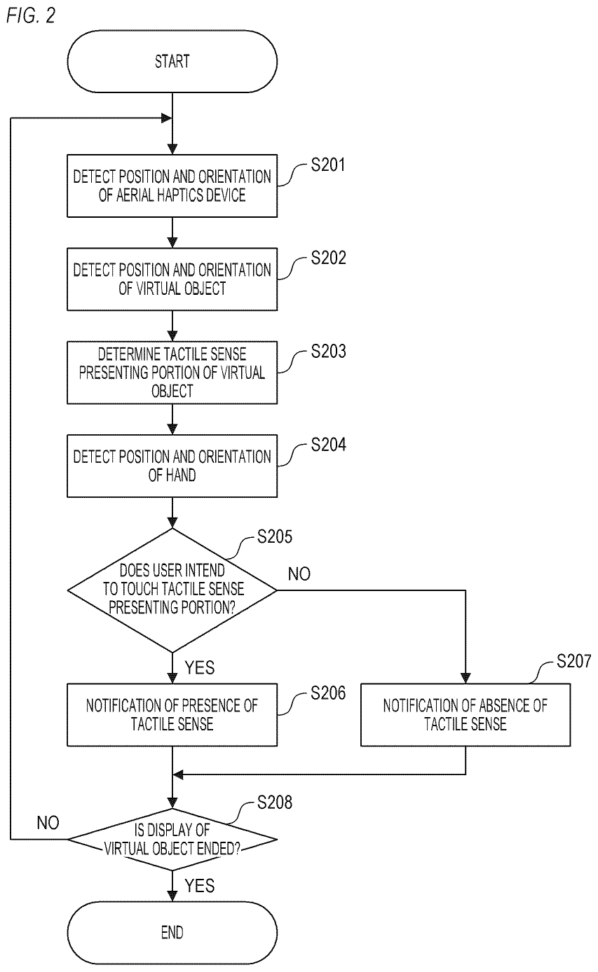

FIG. 2 is a flowchart of tactile sense presence/absence notification processing performed by the display system according to the first embodiment. For example, when connection between the information processing apparatus 100 and the aerial haptics device 101 and the space recognition device 102 is established by the information processing apparatus 100 executing an application for displaying a virtual object, the tactile sense presence/absence notification processing in FIG. 2 is started. In the tactile sense presence/absence notification processing, the information processing apparatus 100 acquires information regarding the positional relationship among the aerial haptics device 101, the virtual object, and the user's hand in a three-dimensional space such as an AR space or an MR space. Then, the information processing apparatus 100 notifies, based on the acquired information, whether a tactile sense is given to the hand when the user touches the virtual object with the hand.

In step S201, the image detection unit 102-4 in the space recognition device 102 detects the aerial haptics device 101 from the image (image representing the real space) obtained by the imaging unit 102-2 in the space recognition device 102 using a known method. As a result, information regarding the position and the orientation of the aerial haptics device 101 in the coordinate space managed by the space recognition device 102 is acquired. The image detection unit 102-4 transmits the acquired information (the position and the orientation of the aerial haptics device 101) to the information processing apparatus 100 (the communication unit 100-9) via the communication unit 102-1.

Note that the image detection unit 100-3 in the information processing apparatus 100 may detect the aerial haptics device 101 from the image (image representing the real space) obtained by the imaging unit 100-7 in the information processing apparatus 100 using a known method. Then, the information processing apparatus 100 or the space recognition device 102 may acquire the information regarding the position and the orientation of the aerial haptics device 101 based on the result of detection by the image detection unit 100-3 and the result of detection by the image detection unit 102-4. The information regarding the position and the orientation of the aerial haptics device 101 may be acquired only based on the result of detection by the image detection unit 100-3.

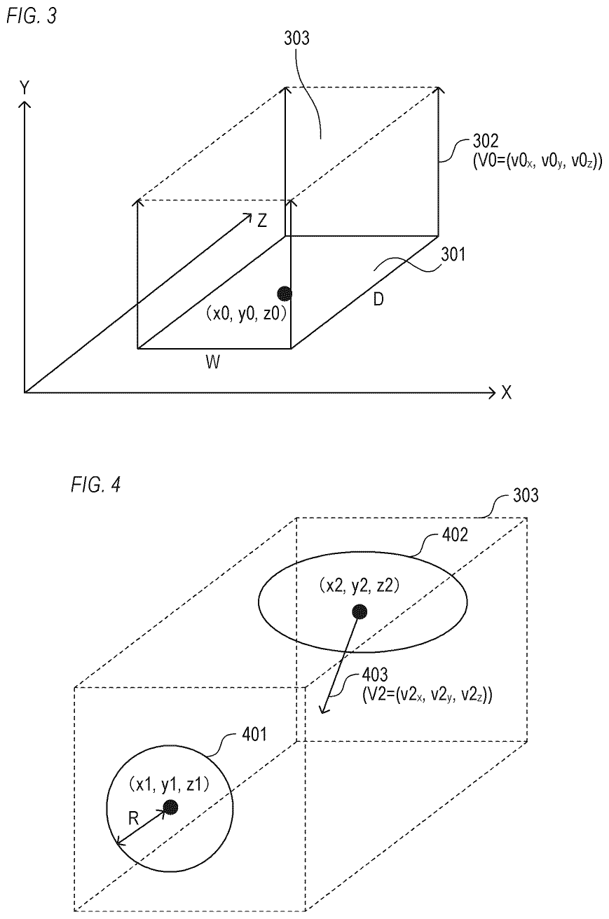

FIG. 3 is a schematic diagram illustrating a coordinate space managed by the space recognition device 102. The coordinate space in FIG. 3 is a three-dimensional space defined by an X axis, a Y axis, and a Z axis. A position (coordinate in X-axis direction, coordinate in Y-axis direction, coordinate in Z-axis direction)=(x0, y0, z0) in FIG. 3 is a center position of the aerial haptics device 101. A region 301 is a region of an output surface (surface from which the ultrasonic wave is output) of the aerial haptics device 101 and is a region of a horizontal size W and a depth size D.

In step S202, the CPU 102-5 in the space recognition device 102 acquires information regarding the position and the orientation of the virtual object in the coordinate space managed by the space recognition device 102 using a known method. Here, the virtual object is a virtual object generated as an image by the image generation unit 100-4 in the information processing apparatus 100. The CPU 102-5 transmits the acquired information (the position and the orientation of the virtual object) to the information processing apparatus 100 (the communication unit 100-9) via the communication unit 102-1. Note that the information regarding the position and the orientation of the virtual object may be generated in the information processing apparatus 100.

FIG. 4 is a schematic diagram illustrating a coordinate space managed by the space recognition device 102. A position (x1, y1, z1) in FIG. 4 is a center position of a virtual object 401. The virtual object 401 is a sphere having a radius R. Note that the shape of the virtual object is not particularly limited, and the virtual object may be expressed in detail using a known method such as voxel modeling. When the virtual object is a sphere, the information on the orientation of the virtual object may not be acquired in step S202.

In step S203, the CPU 100-1 in the information processing apparatus 100 determines a tactile sense presenting portion (and a tactile sense non-presenting portion) of the virtual object based on the information acquired in steps S201 and S202. The tactile sense presenting portion is a portion that gives a tactile sense to the hand when the user touches the virtual object with the hand, and is a portion of the virtual object on a side opposite to a side of the aerial haptics device 101 within a range where the aerial haptics device 101 can give a tactile sense to the hand. The tactile sense non-presenting portion is a remaining portion of the virtual object and is a portion where a tactile sense is not given to the hand when the user touches the virtual object with the hand.

First, the CPU 100-1 determines a range (tactile presentation possible range) in which the aerial haptics device 101 can give a tactile sense to the hand. In FIG. 3, an arrow 302 is a vector indicating a maximum distance from the output surface of the aerial haptics device 101 to a position where tactile sense presentation is possible, and a range 303 is a tactile sense presentation possible range. The vector 302 may be obtained using a known method. The tactile sense presentation possible range 303 can be determined using the horizontal size W, the depth size D, and the vector 302. Here, assuming that the vector 302 is a vector V0=(v0ₓ, v0_{y}, v0_{z}), the tactile sense presentation possible range 303 can be expressed as (x0±W/2+v0ₓ, y0+v0_{y}, z0±D/2+v0_{z}). Although the vector 302 is uniform in the output surface, the vector may not be uniform.

Next, the CPU 100-1 determines the portion of the virtual object included in the tactile sense presentation possible range of the aerial haptics device 101. The region of the virtual object 401 in FIG. 4 is expressed by (x1±R, y1±R, z1±R). Then, as described above, the tactile sense presentation possible range 303 of the aerial haptics device 101 is expressed by (x0±W/2+v0ₓ, y0+v0_{y}, z0±D/2+v0_{z}). The CPU 100-1 determines whether a position (x1+rₓ, y1+r_{y}, z1+r_{z}) in the virtual object 401 satisfies Formula 1. Values of rₓ, r _{y}, and r_{z} are −R to +R, and the CPU 100-1 determines whether Formula 1 is satisfied for each of the plurality of positions in the virtual object 401 while changing the values of rₓ, r_{y}, and r_{z}. Then, the CPU 100-1 determines the portion of the virtual object 401 satisfying Formula 1 as the portion of the virtual object 401 included in the tactile sense presentation possible range.

$$( x 1 + {r}_{x} , y 1 + {r}_{y} , z 1 + {r}_{z} ) ∈ ( x 0 \pm W / 2 + v {0}_{x} , y 0 + v {0}_{y} , z 0 \pm D / 2 + v {0}_{z} ) \qquad ( Formula 1 )$$

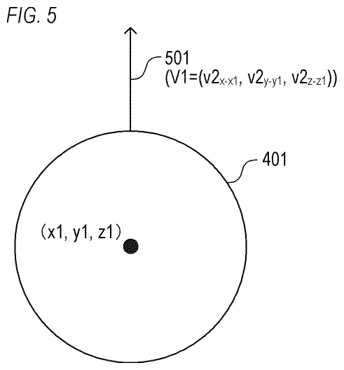

The CPU 100-1 then determines the portion of the virtual object on the side opposite to the side of the aerial haptics device 101. The direction of the vector V0=(v0ₓ, v0_{y}, v0_{z}) is the direction (output direction) of the ultrasonic wave output from the aerial haptics device 101. An arrow 501 illustrated in FIG. 5 is a vector V1=(v1ₓ₋ₓ₁, v1_{y-y1}, v1_{z-z1}) of a normal force that is considered to be received by the user when the user touches the virtual object 401. The vector V1 is a vector directed from the position on the surface of the virtual object 401 to the outside of the virtual object 401, and is also a vector perpendicular to the surface. The CPU 100-1 determines whether Formula 2 is satisfied for each of the plurality of positions on the surface of the virtual object 401. In Formula 2, xadj, yadj, and zadj are parameters indicating an allowable range. The determination as to whether Formula 2 is satisfied may be interpreted as determination as to whether a direction of the normal force is substantially equal to the output direction of the ultrasonic wave. Then, the CPU 100-1 determines the portion of the virtual object 401 for which Formula 2 is satisfied as the portion of the virtual object 401 on the side opposite to the side of the aerial haptics device 101. Note that the output direction (vector V0) of the ultrasonic wave can be obtained based on the orientation of the aerial haptics device 101. The output direction of the ultrasonic wave may be all directions of 360 degrees, and in this case, the information on the orientation of the aerial haptics device 101 may not be acquired in step S201.

$$( v {1}_{x - x 1} , v {1}_{y - y 1} , v {1}_{z - z 1} ) ∈ ( v {0}_{x} \pm adj , v {0}_{y} \pm yadj , v {0}_{z} \pm zadj ) \qquad ( Formula 2 )$$

Then, the CPU 100-1 determines a portion of the virtual object on the side opposite to the side of the aerial haptics device 101 within the tactile sense presentation possible range of the aerial haptics device 101 as the tactile sense presenting portion of the virtual object. For example, the CPU 100-1 determines the portion of the virtual object 401 that satisfies both Formulas 1 and 2 as the tactile sense presenting portion of the virtual object 401.

The description returns to FIG. 2. In step S204, the image detection unit 102-4 in the space recognition device 102 detects the hand (the user's hand) from the image (image representing the real space) obtained by the imaging unit 102-2 in the space recognition device 102 using a known method. As a result, information regarding the position and the orientation of the hand in the coordinate space managed by the space recognition device 102 is acquired. Furthermore, the image detection unit 102-4 acquires information regarding motion of the hand from a temporal change in the position and the orientation of the hand. The image detection unit 102-4 transmits the acquired information (the position, the orientation, and the motion of the hand) to the information processing apparatus 100 (the communication unit 100-9) via the communication unit 102-1.

Note that the image detection unit 100-3 in the information processing apparatus 100 may detect the hand from the image (image representing the real space) obtained by the imaging unit 100-7 in the information processing apparatus 100 using a known method. Then, the information processing apparatus 100 or the space recognition device 102 may acquire the information regarding the position and the orientation of the hand based on the result of detection by the image detection unit 100-3 and the result of detection by the image detection unit 102-4. The information regarding the position and the orientation of the hand may be acquired only based on the result of detection by the image detection unit 100-3.

A position (x2, y2, z2) in FIG. 4 is the position of the hand 402. The position of the hand 402 (x2, y2, z2) may be a center position of a palm, a position of a fingertip, or the like. Although the hand 402 is considered a sphere in FIG. 4 for simplicity, the detailed shape of the hand 402 may be considered using a known method such as voxel modeling. An arrow 403 in FIG. 4 indicates a motion vector V2=(v2ₓ, v2_{y}, v2_{z}) of the hand 402 calculated from a temporal change of the position of the hand 402.

In step S205, the CPU 100-1 in the information processing apparatus 100 determines whether the user intends (attempts) to touch the tactile sense presenting portion of the virtual object with the hand based on the information obtained in steps S203 and S204. In the first embodiment, the CPU 100-1 determines whether all of the following conditions 1 to 5 are satisfied. These determinations may be interpreted as determinations as to whether the tactile sense is given to the hand when the user touches the virtual object with the hand. A case where all of the conditions 1 to 5 are satisfied may be interpreted as a case where the user intends to touch the tactile sense presenting portion of the virtual object with a hand or may be interpreted as a case where the tactile sense is given to the hand when the user touches the virtual object with the hand. This case proceeds to step S206. A case where at least any of the conditions 1 to 5 are not satisfied may be interpreted as a case where the user does not intend to touch the tactile sense presenting portion of the virtual object with a hand or may be interpreted as a case where the tactile sense is not given to the hand when the user touches the virtual object with the hand. This case proceeds to step S207.
Condition 1: The hand is within the tactile sense presentation possible range of the aerial haptics device 101.
Condition 2: The hand is within the predetermined range from the tactile sense presenting portion of the virtual object.
Condition 3: The hand is moving closer to the aerial haptics device 101.
Condition 4: The palm of the hand faces the tactile sense presenting portion of the virtual object.
Condition 5: the Virtual Object Is Stationary.

Note that the condition used in step S205 is not limited to the above conditions 1 to 5. For example, as the condition 3, a condition that the motion direction (motion vector V2=direction of (v2ₓ, v2_{y}, v2_{z})) of the hand is substantially equal to a reverse direction of the output direction (the direction of the vector V0=(v0ₓ, v0_{y}, v0_{z})) of the ultrasonic wave (a condition that Formula 3 is satisfied) may be used. In Formula 3, xadj′, yadj′, and zadj′ are parameters indicating an allowable range. At least one of the conditions 4 and 5 may not be used. When the condition 4 is not used, the information on the orientation of the hand may not be acquired in step S204. A condition that the hand moves so as to approach the tactile sense presenting portion of the virtual object may be used.

$$( v {2}_{x} , v {2}_{y} , v {2}_{z} ) ∈ ( - v {0}_{x} \pm {xadj}^{′} , - v {0}_{y} \pm {yadj}^{′} , - v {0}_{z} \pm {zadj}^{′} ) \qquad ( Formula 3 )$$

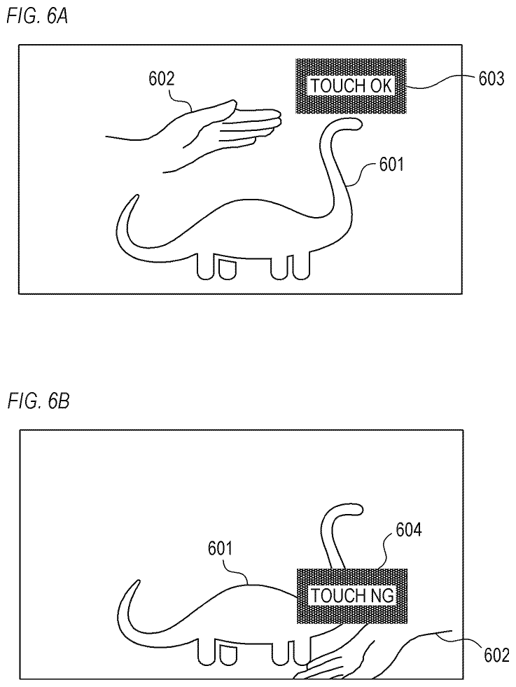

In step S206, the CPU 100-1 in the information processing apparatus 100 performs control to notify the user that the tactile sense is given to the hand when the user touches the virtual object with the hand. In the first embodiment, the CPU 100-1 instructs the image generation unit 100-4 to generate a tactile sense presentation item (notification data) indicating that the tactile sense is given to the hand when the user touches the virtual object with the hand. Then, the CPU 100-1 instructs the image processing unit 100-2 to generate a display image including the tactile sense presentation item. When the processing of step S206 is performed, for example, the display image illustrated in FIG. 6A is displayed on the display unit 100-8. In the display image of FIG. 6A, a virtual object 601, a user's hand 602, and a tactile sense presentation item 603 are displayed. The tactile sense presentation item 603 may be displayed at a portion overlapping the virtual object 601, the hand 602, or the like but is preferably displayed at a portion avoiding the virtual object 601, the hand 602, or the like.

In step S207, the CPU 100-1 in the information processing apparatus 100 performs control to notify the user that the tactile sense is not given to the hand when the user touches the virtual object with the hand. In the first embodiment, the CPU 100-1 instructs the image generation unit 100-4 to generate a tactile sense non-presentation item (notification data) indicating that the tactile sense is not given to the hand when the user touches the virtual object with the hand. Then, the CPU 100-1 instructs the image processing unit 100-2 to generate a display image including the tactile sense non-presentation item. When the processing of step S207 is performed, for example, the display image illustrated in FIG. 6B is displayed on the display unit 100-8. In the display image of FIG. 6B, the virtual object 601, the hand 602, and a tactile sense non-presentation item 604 are displayed. The tactile sense non-presentation item 604 may be displayed at a portion avoiding the virtual object 601, the hand 602, or the like but is preferably displayed at a portion overlapping the virtual object 601, the hand 602, or the like. By displaying the tactile sense non-presentation item 604 at a portion overlapping the virtual object 601, the hand 602, or the like, it is possible to suppress contact with the tactile sense non-presenting portion.

Note that an example has been described in which, when the user touches the virtual object with the hand, whether the tactile sense is given to the hand is notified by display, but the notification method is not limited thereto. For example, when the user touches the virtual object with the hand, whether the tactile sense is given to the hand may be notified by voice or the like.

In step S208, the CPU 100-1 in the information processing apparatus 100 determines whether an instruction to end the display of the virtual object (for example, an instruction to hide a virtual object, or an instruction to end an application that displays a virtual object) has been performed by the user. In a case where an instruction to end the display of the virtual object has been performed, the processing proceeds to step S201, and otherwise, the tactile sense presence/absence notification processing of FIG. 2 ends.

As described above, according to the first embodiment, whether the tactile sense is given to the hand when the user touches the virtual object with the hand is notified based on the positional relationship among the aerial haptics device, the virtual object, and the user's hand. This makes it possible to suppress occurrence of discomfort of the user in aerial haptics. For example, since the user can quickly and easily grasp whether the tactile sense is given to the hand when the user touches the virtual object with the hand (before touching the virtual object), the user does not feel uncomfortable even if the tactile sense cannot be obtained when the user touches the virtual object.

### Second Embodiment

A second embodiment of the present disclosure is described. In the first embodiment, whether the tactile sense is given to the hand when the user touches the virtual object with the hand is notified by displaying the tactile sense presentation item or the tactile sense non-presentation item. In the second embodiment, image processing is performed on the image of the virtual object so as to indicate whether the tactile sense is given to the hand when the user touches the virtual object with the hand, and the image of the virtual object after the image processing is displayed. Note that, hereinafter, description of configurations and processing similar to those of the first embodiment are omitted, and configurations and processing different from those of the first embodiment are described.

### Tactile Sense Presence/Absence Notification Processing

The processing in steps S201 to S205 and S208 in FIG. 2 is the same between the first and second embodiments, and the processing in steps S206 and S207 is different.

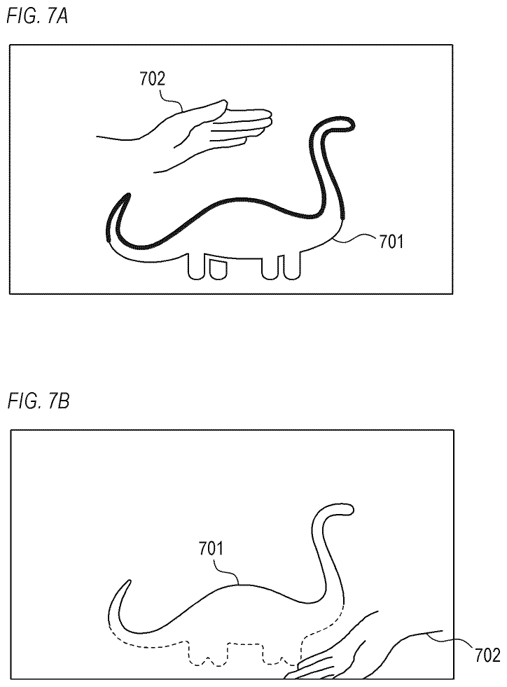

In step S206, the CPU 100-1 in the information processing apparatus 100 instructs the image processing unit 100-2 to execute image processing on the region of the tactile sense presenting portion of the virtual object in the display image. The image processing on the region of the tactile sense presenting portion may be processing of enhancing saliency (conspicuousness) of the region of the tactile sense presenting portion or may be processing of changing at least one of color, resolution, and contrast. For example, the image processing on the region of the tactile sense presenting portion may include at least one of processing of darkening the color (change in brightness or saturation), processing of inverting the color (change in hue), processing of increasing resolution, and processing of enhancing contrast. When the processing of step S206 is performed, for example, the display image illustrated in FIG. 7A is displayed on the display unit 100-8. In the display image of FIG. 7A, a virtual object 701 and a user's hand 702 are displayed. Then, the saliency of the region of the tactile sense presenting portion is enhanced by the image processing. By viewing the display image after the image processing in step S206, the user can quickly and easily grasp that the tactile sense is given to the hand when the user touches the tactile sense presenting portion of the virtual object with the hand.

In step S207, the CPU 100-1 in the information processing apparatus 100 instructs the image processing unit 100-2 to execute image processing on the region of the tactile sense non-presenting portion of the virtual object in the display image. The image processing on the region of the tactile sense non-presenting portion may be processing of reducing saliency of the region of the tactile sense non-presenting portion or may be processing of changing at least one of color, resolution, and contrast. For example, the image processing on the region of the tactile sense non-presenting portion may include at least one of processing of lightening the color (change in brightness or saturation), processing of reducing resolution, and processing of reducing contrast. When the processing of step S207 is performed, for example, the display image illustrated in FIG. 7B is displayed on the display unit 100-8. In the display image of FIG. 7B, the virtual object 701 and the user's hand 702 are displayed. Then, the saliency of the region of the tactile sense non-presenting portion is reduced by the image processing. By viewing the display image after the image processing in step S207, the user can quickly and easily grasp that the tactile sense is not given to the hand when the user touches the tactile sense non-presenting portion of the virtual object with the hand.

Note that the image processing is not particularly limited as long as the image of the virtual object after the image processing indicates whether the tactile sense is given to the hand when the user touches the virtual object with the hand. For example, at least one of the image processing in step S206 and the image processing in step S207 may be always performed.

As described above, according to the second embodiment, based on the positional relationship among the aerial haptics device, the virtual object, and the user's hand, image processing is performed on the image of the virtual object so as to indicate whether the tactile sense is given to the hand when the user touches the virtual object with the hand. Then, the image of the virtual object after the image processing is displayed. In this manner, it is possible to obtain the same effect as the effect of the first embodiment.

### Third Embodiment

A third embodiment of the present disclosure is described. In the first and second embodiments, when the user touches the virtual object with the hand, whether the tactile sense is given to the hand is notified. In the third embodiment, when the user touches the virtual object with the hand, an intensity of the tactile sense given to the hand is further notified. Note that, hereinafter, description of configurations and processing similar to those of the first and second embodiments are omitted, and configurations and processing different from those of the first and second embodiments are described.

### Tactile Sense Presence/Absence Notification Processing

The processing in steps S201, S202, S204, S205, S207, and S208 in FIG. 2 is the same between the first and second embodiments and the third embodiment, and the processing in steps S203 and S206 is different.

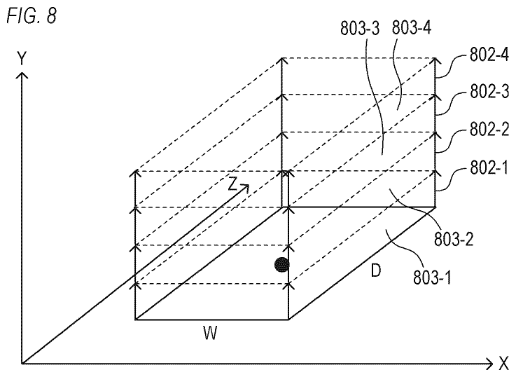

In step S203, the CPU 100-1 in the information processing apparatus 100 determines a tactile sense presenting portion (and a tactile sense non-presenting portion) of the virtual object based on the information acquired in steps S201 and S202. The method of determining the tactile sense presenting portion is generally the same between the first and second embodiments and the third embodiment, and the CPU 100-1 determines a tactile sense presentation possible range of the aerial haptics device 101 to determine the tactile sense presenting portion of the virtual object. Since the ultrasound wave output from the aerial haptics device 101 becomes weaker as it goes farther from the aerial haptics device 101, the tactile sense given to the user from the aerial haptics device 101 also becomes weaker as it goes farther from the aerial haptics device 101. Therefore, in the third embodiment, as illustrated in FIG. 8, the CPU 100-1 divides the vector V0 indicating the maximum distance from the output surface of the aerial haptics device 101 to the position where tactile sense presentation is possible into four vectors 802-1 to 802-4 in the same direction. Then, the CPU 100-1 determines four ranges 803-1 to 803-4 corresponding to the four vectors 802-1 to 802-4, respectively, as the tactile sense presentation possible range of the aerial haptics device 101. Thereafter, the CPU 100-1 determines the tactile sense presenting portion of the virtual object by dividing the tactile sense presenting portion into a portion included in the range 803-1, a portion included in the range 803-2, a portion included in the range 803-3, and a portion included in the range 803-4. Then, the CPU 100-1 associates a stronger intensity with the portion as the portion is closer to the aerial haptics device 101.

Note that a method of dividing the vector V0 into a plurality of vectors is not particularly limited, and the vectors 802-1 to 802-4 may or may not be uniform in magnitude. The vector V0 may be divided into vectors of a number smaller than four (two or three), or the vector V0 may be divided into vectors of a number larger than four.

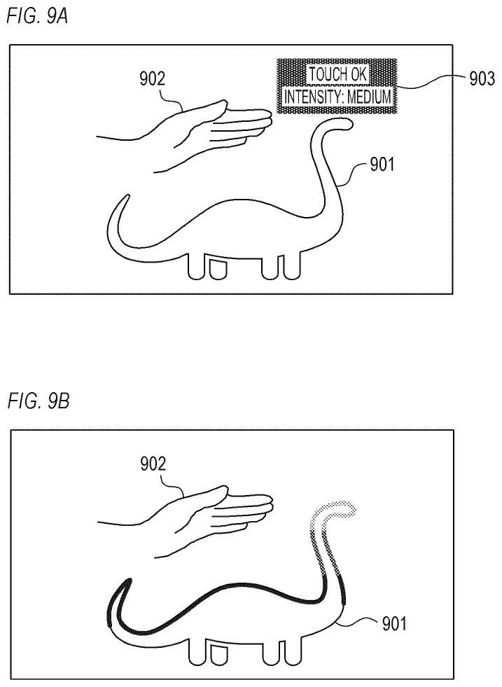

In step S206, the CPU 100-1 in the information processing apparatus 100 performs control to notify the user that the tactile sense is given to the hand when the user touches the virtual object with the hand. Furthermore, the CPU 100-1 performs control to notify the user of the intensity of the tactile sense given to the hand when the user touches the virtual object with the hand. In the third embodiment, the CPU 100-1 determines a contact target portion, which is a portion that the user intends to touch with the hand, in the tactile sense presenting portion of the virtual object based on the information obtained in steps S203 and S204. The portion included in the range 803-1, the portion included in the range 803-2, the portion included in the range 803-3, or the portion included in the range 803-4 is determined as the contact target portion. A portion closest to the hand may be determined as the contact target portion, or a portion to which the palm is directed may be determined as the contact target portion. The CPU 100-1 instructs the image generation unit 100-4 to generate a tactile sense presentation item (notification data) indicating that the tactile sense is given to the hand when the virtual object is touched with the hand and the intensity corresponding to the determined tactile sense target portion. Then, the CPU 100-1 instructs the image processing unit 100-2 to generate a display image including the tactile sense presentation item. When the processing of step S206 is performed, for example, the display image illustrated in FIG. 9A is displayed on the display unit 100-8. In the display image of FIG. 9A, a virtual object 901, a user's hand 902, and a tactile sense presentation item 903 are displayed. The tactile sense presentation item 903 indicates that the tactile sense is given to the hand when the virtual object is touched with a hand, and an intensity corresponding to the determined tactile sense target portion.

The intensity notification method is not limited to the above method. As an example, a case will be considered in which a user is notified that the tactile sense is given to the hand when the user touches the tactile sense presenting portion of the virtual object with the hand by the method of the second embodiment. In this case, the CPU 100-1 in the information processing apparatus 100 instructs the image processing unit 100-2 to execute image processing on the region of the tactile sense presenting portion of the virtual object in the display image. At that time, the CPU 100-1 instructs the image processing unit 100-2 to execute image processing in consideration of the intensity of each portion in the tactile sense presenting portion. For example, the CPU 100-1 instructs the image processing unit 100-2 to darken the color as the intensity is higher, to increase resolution as the intensity is higher, or to enhance contrast as the intensity is higher. The color may be lighter as the intensity is lower, the resolution may be decreased as the intensity is lower, or the contrast may be decreased as the intensity is lower. In this case, for example, the display image illustrated in FIG. 9B is displayed on the display unit 100-8. In the display image of FIG. 9B, the virtual object 901 and the user's hand 902 are displayed. Then, the color of the region of the tactile sense presenting portion is changed to a color corresponding to the intensity by the image processing.

In addition, the tactile sense obtained when the virtual object is moving is different from the tactile sense obtained when the virtual object is stationary. Therefore, image processing in further consideration of the magnitude of motion of the virtual object may be executed.

As described above, according to the third embodiment, the user is notified of not only whether the tactile sense is given to the hand when the user touches the virtual object with the hand, but also the intensity of the tactile sense given to the hand when the user touches the virtual object with the hand. This makes it possible to more reliably suppress occurrence of discomfort of the user in aerial haptics. The user can quickly and easily grasp not only whether the tactile sense is given to the hand when the user touches the virtual object with the hand, but also the intensity of the tactile sense given to the hand when the user touches the virtual object with the hand. As a result, the user does not feel discomfort even if the tactile sense obtained when the user touches the virtual object is weak.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037715, filed Mar. 10, 2025, which is hereby incorporated by reference herein in its entirety.

What is claimed is:

1. An electronic device comprising:
a processor; and
a memory storing a program which, when executed by the processor, causes the electronic device to
perform an acquisition process that acquires information regarding a positional relationship between each of a tactile sense generation device, a virtual object, and a user's hand in a three-dimensional space, and
perform a control process to notify to the user whether a tactile sense is applied the user's hand when the user touches the virtual object with the user's hand based on the information acquired by the acquisition process.

2. The electronic device according to claim 1,
wherein, the acquisition process acquires information regarding a position and an orientation of the tactile sense generation device in the three-dimensional space, information regarding a position and an orientation of the virtual object in the three-dimensional space, and information regarding a position and an orientation of the hand in the three-dimensional space.

3. The electronic device according to claim 1,
wherein, the control process includes determining, based on the information acquired by the acquisition process, whether the tactile sense is being applied the user's hand when the user touches the virtual object with the user's hand.

4. The electronic device according to claim 3,
wherein, the control process includes,
the determination that the tactile sense is applied to the user's hand when the user touches the virtual object with the user's hand includes
a determination result indicating whether the user attempts to touch, with the user's hand, a portion of the virtual object on a side opposite to a side of the tactile sense generation device within a range where the tactile sense generation device is able to provide the tactile sense to the hand.

5. The electronic device according to claim 4,
wherein, in the control process,
the determination that the tactile sense is applied to the user's hand when the user touches the virtual object with the user's hand includes,
a determination on whether all of a plurality of conditions are satisfied is performed, the conditions including
a condition that the user's hand is within the range where the tactile sense generation device is capable of providing the tactile sense to the user's hand,
a condition that the user's hand is within a predetermined range from the portion of the virtual object, and
a condition that the user's hand moves to approach the tactile sense generation device within a predetermined distance.

6. The electronic device according to claim 5,
wherein the plurality of conditions further include a condition that a palm of the user's hand faces the portion of the virtual object.

7. The electronic device according to claim 5,
wherein the plurality of conditions further include a condition that the virtual object is stationary.

8. The electronic device according to claim 1,
wherein, the control process is performed to notify, by display, whether the tactile sense is applied to the hand when the user touches the virtual object with the hand.

9. The electronic device according to claim 1,
wherein, the control process includes
image processing performed on an image of the virtual object to indicate whether the tactile sense is applied to the hand when the user touches the virtual object with the user's hand based on the information acquired by the acquisition process, and
control is performed to display an image of the virtual object after the image process.

10. The electronic device according to claim 9,
wherein a portion of the virtual object on a side opposite to a side of the tactile sense generation device within a range where the tactile sense generation device is able to provide the tactile sense to the user's hand is a tactile sense presenting portion where the tactile sense is applied to the hand when the user touches the virtual object with the hand,
a remaining portion of the virtual object is a tactile sense non-presenting portion where the tactile sense is not provided to the hand when the user touches the virtual object with the user's hand, and
in the control process, image processing is performed on at least one of a region of the tactile sense presenting portion and a region of the tactile sense non-presenting portion in the image of the virtual object.

11. The electronic device according to claim 10,
wherein, in the control process,
in a case of notifying that the tactile sense is applied to the hand when the user touches the virtual object with the user's hand, the image processing is not performed on the region of the tactile sense non-presenting portion, and the image processing is performed on the region of the tactile sense presenting portion, and
in a case of notifying that the tactile sense is not applied to the hand when the user touches the virtual object with the user's hand, the image processing is not performed on the region of the tactile sense presenting portion, and image processing is performed on the region of the tactile sense non-presenting portion.

12. The electronic device according to claim 10,
wherein the image processing performed on the region of the tactile sense presenting portion is a process of enhancing saliency of the region of the tactile sense presenting portion, and
the image processing performed on the region of the tactile sense non-presenting portion is a process of reducing saliency of the region of the tactile sense non-presenting portion.

13. The electronic device according to claim 9,
wherein the image processing is a color change process that changes at least one of color, resolution, and contrast.

14. The electronic device according to claim 10,
wherein, in the control process, the image processing is performed on an image of the virtual object based on an intensity of the tactile sense applied to the user's hand when the user touches the virtual object with the user's hand.

15. The electronic device according to claim 10,
wherein, in the control process, the image processing is performed on the image of the virtual object based on a magnitude of motion of the virtual object.

16. The electronic device according to claim 1,
wherein, in the control process, control is performed to further notify an intensity of a tactile sense applied to the user's hand when the user touches the virtual object with the user's hand.

17. A control method of an electronic device, comprising:
acquiring information regarding a positional relationship between each of a tactile sense generation device, a virtual object, and a user's hand in a three-dimensional space; and
performing control so as to notify to the user whether a tactile sense is applied the user's hand when the user touches the virtual object with the user's hand based on the acquired information.

18. A non-transitory computer readable medium that stores a program, wherein the program causes a computer to execute a control method of an electronic device, the control method comprising:
acquiring information regarding a positional relationship between each of a tactile sense generation device, a virtual object, and a user's hand in a three-dimensional space; and
performing control so as to notify to the user whether a tactile sense is applied the user's hand when the user touches the virtual object with the user's hand based on the acquired information.
